(19) United States
(12) Patent Application Publication
(10) Pub. No.: US 2014/0297678 A1
(43) Pub. Date: Oct. 2, 2014

(54) METHOD FOR SEARCHING AND SORTING DIGITAL DATA

(71) Applicant: Cherif Atia Algreatly, Palo Alto, CA (US)

(72) Inventor: Cherif Atia Algreatly, Palo Alto, CA (US)

(21) Appl. No.: 13/851,824

(22) Filed: Mar. 27, 2013

(51) Int. Cl. G06F 17/30

(52) U.S. Cl. CPC G06F 17/30477
USPC 707/769

(57) ABSTRACT

A method for searching digital data such as text, pictures, videos, or audio is disclosed. The method allows a user to select a part of a digital data and retrieve accurate search results related to this part, according to the content of the digital data. Also, a method for sorting through digital data such as text, pictures, videos, or audio is disclosed. The method enables sorting parts of a digital data associated with keywords describing the relationship between these parts and the digital data, which enables retrieving classified search results that meet the users' needs.

### CROSS-REFERENCE TO RELATED APPLICATION

This application claims the benefits of a U.S. Provisional Patent Application No. 61/690,455, filed Jun. 26, 2012, the entire contents of which are incorporated herein by reference.

### BACKGROUND

The four main categories of digital data are text, pictures, videos, and audios, each of which is comprised of certain parts. For example, the text consists of words, the picture consists of objects, the video consists of frames, and the audio consists of vocal information or music. The available methods for selecting a part of a digital data and searching for information related to this part do not put into consideration the relationship between the selected part and the content of its digital data. For example, when searching for information for a selected word of a text, the search engine ignores the content of the text and only considers the selected word during the search process. Also, when searching for information for a selected object located in a picture, the search engine ignores the other objects of the picture and only considers the selected object during the search process. Accordingly, the search results are not specific or accurate enough for each different content of a digital data.

During sorting a part of a digital data for searching purpose the sorting process ignores the relationship between this part and the content of its digital data. Moreover, the sorting process does not associates any classifications related to the digital data with this part. Accordingly, the search results, in many cases, are not classified in a manner that meets the user's needs. For example, in an educational application, when using a search engine to search for a word such as “Pyramid”, the search engine does not classify the search results according to the subject, educational level, or source of information. For example, in this case the subject can be Geometry, History, or Engineering. The level of education can be a level equivalent to Elementary School, High school, Undergraduate, or Graduate Studies. The source of information can be a website, electronic book, or newspaper. Such classification enables the user to get the search results according to his/her needs or preference.

Generally, there is no available technology or method that approaches the aforementioned two problems of searching and sorting the digital data, while the present invention introduces a method that solves these two problems as will be described subsequently.

### SUMMARY

The present invention introduces a first method for selecting a part of a first digital data to be augmented with a related content of a second digital data. The first digital data can be a text, picture, video, or audio. The part of the first digital data can be a word of a text, an area of a picture, a frame of a video, or a time period of an audio. The second digital data can be text, pictures, videos, or audios. The second digital data is displayed in a window specified by a location and dimensions relative to the first digital data. The method is utilized with mobile phones, tablets, and head mounted computer displays in the form of eyeglasses.

Also the present invention introduces a second method for sorting layers of digital data. The method comprising of; classifying a first layer of a first digital data with a plurality of identifiers; associating a part of the first digital data with a second layer of a second digital data described with a type, source and search keyword representing the relationship of this part with the first digital data; and retrieving the second digital data from the source when providing the search keyword, the type, and the plurality of identifiers. The first digital data and the second digital data can be text, pictures, videos, or audios.

The present invention introduces a third method for sorting and searching annotations. The method comprising of; classifying a first layer of a first digital data with a plurality of identifiers; associating a selected part of the first digital data with a second layer of annotations; assigning the selected part with search keywords representing the relationship of the selected part and the first digital data; storing the annotations associated with the search keywords and the plurality of identifiers; and retrieving the annotations when providing the search keywords and the identifiers. The first digital data can be text, pictures, videos, or audios.

### BRIEF DESCRIPTION OF DRAWINGS

FIG. 1 illustrates a first layer of a first digital data in the form of text where a word of the text is selected to be augmented with a second layer of a second digital data related to this word.

FIG. 2 illustrates a first layer of a first digital data in the form of picture where an area of this picture is selected to be augmented with a second layer of a second digital data related to the objects located in this picture's area.

FIG. 3 illustrates a first layer of a first digital data in the form of video where a frame of the video is selected to be augmented with a second layer of a second digital data related to the content of this frame.

FIG. 4 illustrates a first layer of a first digital data in the form of audio where a time period of the audio is selected to be augmented with a second layer of a second digital data related to the vocal information located in this time period of the audio.

FIG. 5 illustrates providing a search engine with a search keyword and classification criteria to retrieve search results meeting these classification criteria.

### DETAILED DESCRIPTION

In one embodiment of the present invention, a method for augmenting layers of digital data is disclosed. The method comprising of; presenting a first layer of a first digital data that can be described with global keywords, selecting a part of the first digital data that can be described with partial keywords whereas this part is to be augment with a second layer of a second digital data, providing a first input representing the type of the second digital data; providing a second input representing the source of the second digital data, providing a third input representing a predefined position for presenting the second digital data; analyzing the partial keywords relative to the global keywords to generate search keywords, extracting the second digital data from the source according to the search keywords; and presenting the second digital data in the predefined position.

In another embodiment of the present invention, the first digital data is a digital text presented on a device display where the global keywords are the main keywords that describe this digital text. The part selected of the first digital data is one word or more whereas the partial keywords of this part are the same one word or more. The second digital data is augmented with the first digital data to be presented simultaneously on the device display. The type of the second digital data is text, pictures, videos, or audios. The source of the second digital data contains text, pictures, videos, and audios in a digital format. The predefined position is a window defined with dimensions and location relative to the part selected of the text on the display. The analyzing of the partial keywords relative to the global keywords means combining all possible alternatives of the one word or more with the global keywords creating a list of search keywords then eliminating the alternatives of the search keywords that do not have related content in the source. The extracting of the second digital data means retrieving digital text, digital pictures, digital videos, or digital audios from the source according to the type and the search keywords remained of the list of the search keywords. The presenting of the second digital data means displaying the digital text, digital pictures, digital videos, or digital audios extracted from the source inside the window of the predefined position.

In another embodiment of the present invention, the first digital data is a picture containing objects presented on a device display where the global keywords are the main keywords that describe the picture's contents. This is achieved by using the tags, captions, or any information associated with the picture describing the picture's contents, or by using an object recognition technique, as known in the art, to define the objects in the picture. The part selected of the first digital data is an area drawn on top of the picture containing one object or more of the picture's objects whereas the partial keywords of this part describe this one object or more using an object recognition technique. The second digital data is augmented with the first digital data to be presented simultaneously on the device display. The type of the second digital data is text, pictures, videos, or audio. The source of the second digital data contains text, pictures, videos, and audio in a digital format. The predefined position is a window defined with dimensions and location relative to the part selected of the picture on the display. The analyzing of the partial keywords relative to the global keywords means combining all possible alternatives of the partial keywords with the global keywords creating a list of search keywords then eliminating the alternatives of the search keywords that do not have related content in the source. The extracting of the second digital data means retrieving text, pictures, videos, or audio from the source according to the type and the search keywords remained of the list of the search keywords. The presenting of the second digital data means displaying the text, pictures, videos, or audio extracted from the source inside the window of the predefined position.

If the entire picture was selected instead of an area or a part of the picture, in this case, the partial keywords are the global keywords, which leads to extracting and presenting a second digital data related to the entire picture and not only related to a specific part of the picture. If the picture represents a real time scene presented on a display of a digital camera, in this case, the user can select an area or part of this real time scene or select the entire real time scene to extract and display a second digital data related to the user's selection. The second digital data changes every time the picture of the real time scene changes when moving or tilting the digital camera to capture a different scene.

In one embodiment of the present invention, the first digital data is a video containing objects presented on a device display where the global keywords are the main keywords that describe the video's contents. This is achieved by using the title, captions, or any information associated with the video describing the video's contents, or by using an object recognition technique, as known in the art, to define the objects in the successive frames of the video. The part selected of the first digital data is a frame of the video at a certain moment whereas this frame contains one object or more, and the partial keywords of this frame describe this one object or more using an object recognition technique. The second digital data is augmented with the first digital data to be presented simultaneously on the device display. The type of the second digital data is text, pictures, videos, or audio. The source of the second digital data contains text, pictures, videos, and audio in a digital format. The predefined position is a window defined with dimensions and location relative to the position of the video on the display. The analyzing of the partial keywords relative to the global keywords means combining all possible alternatives of the partial keywords with the global keywords creating a list of search keywords then eliminating the alternatives of the search keywords that do not have related content in the source. The extracting of the second digital data means retrieving text, pictures, videos, or audio from the source according to the type and the search keywords remained of the list of the search keywords. The presenting of the second digital data means displaying the text, pictures, videos, or audio extracted from the source inside the window of the predefined position.

If the video is presenting a plurality of slides containing text, in this case, an optical character recognition technique is utilized to convert the content of the video and the selected frame into digital text. If the user selected one word or more of a frame or slide instead of selecting the entire frame or slide, in this case, the partial keywords represent this one word or more.

In another embodiment of the present invention, the first digital data is an audio containing vocal information and this audio is played on a device display. The global keywords are the main keywords that describe the content of the vocal information of the audio using a speech-to-text conversion technique as known in the art. The selected part of the audio is defined with a time period when playing the audio containing one word or more of the vocal information. The one word or more of the part are defined using a speech-to-text conversion technique, where the partial keywords describe this one word or more. The second digital data is to be presented on the device display while the audio is simultaneously playing. The type of the second digital data is text, pictures, videos, or audios. The source of the second digital data contains text, pictures, videos, and audios in a digital format. The predefined position is a window defined with dimensions and location on the device display. The analyzing of the partial keywords relative to the global keywords means combining all possible alternatives of the partial keywords with the global keywords creating a list of search keywords, then eliminating the alternatives of the search keywords in the list that do not have related content in the source. The extracting of the second digital data means retrieving text, pictures, videos, or audios from the source according to the type and the search keywords remained of the list of the search keywords. The presenting of the second digital data means displaying the text, pictures, videos, or audio extracted from the source inside the window of the predefined position.

The audio may represent a real time vocal information that is received and recorded by a digital recorder of a device. The user can select any part of the real time vocal information by pressing twice on an icon on the device display to determine the start time and the end time of the selected part of the real time vocal information. Accordingly, the second digital data is extracted and presented on the device display once the selected part is completely defined when pressing the icon for the second time.

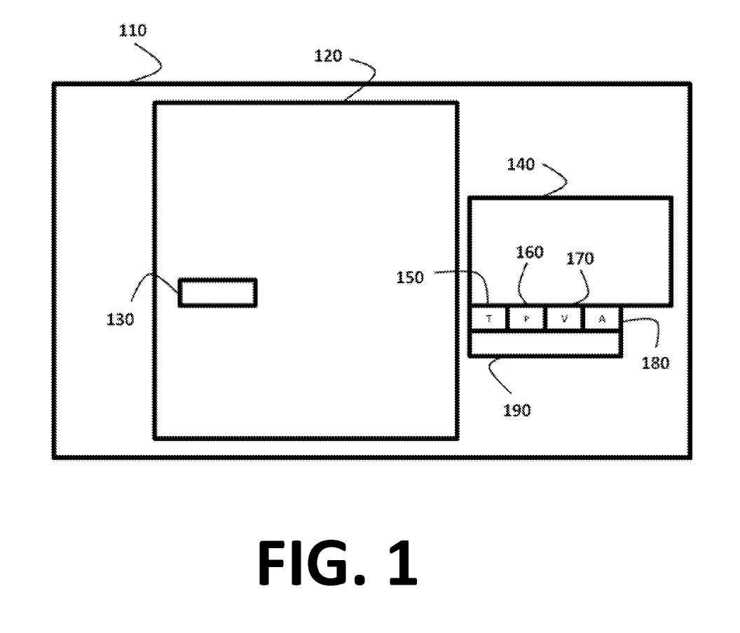

Generally, the device display can be a screen of a mobile phone, tablet, computer, or head mounted computer in the form of eyeglasses. For example, FIG. 1 illustrates a display 110 presenting a first layer of a digital data 120 in the form of a text where a word 130 of this text is manually selected by a user. Once a word or more are selected, the user can manually draw a window 140 on the display, as shown in the figure, to indicate the location of the second digital data. The text icon 150, the picture icon 160, the video icon 170, and the audio icon 180 are four alternatives available to the user to select the type of the second digital data. The source box 190 enables the user to type the source of the second digital data. For example, a user can type a name of a search engine such as “GOOGLE Search Engine” or “BING Search Engine”, or type a name of an electronic books library such as “MIT Online Library”, or type a URL of a website such as “www.cnn.com”. Once a user indicates the type and source of the second digital data, the window presents the second digital data according to the selected word, the content of the first digital data, and the type and source of the second digital data.

As described previously, content of the first digital data is represented by the global keywords. For example, if the topic of the previous example is about “Augmented Reality” and the global keywords of its text are; “Augmented”, “Reality”, “Smartphone”, “GPS”, and “Google”, while the selected part is the word “Glasses” then the partial keywords are also the word “Glasses”. Combination the partial keywords with the global keywords leads to five alternatives as follow; “Augmented Glasses”; “Reality Glasses”; “Smartphone Glasses”; “GPS Glasses”; and “Google Glasses”. Checking the source of the second digital data against the five alternatives indicates which one of the five alternatives has a related content in the source. In this case, the alternatives that do not have related content in the source will not be utilized to extract the second digital data, while the alternatives that have related content in the source will be utilized to extract the second digital data.

The text of the previous example can be a text of an electronic book (“ebook”), a text of a Web site page, a text typed by a user on a computer application, or the like. As described previously, selecting the type of the second digital data controls the format of the second digital data presented in the window on the display. For example, In FIG. 1 if a user selects the text icon, the window presents text related to the selected word within the content of the topic. If a user selects the picture icon, the window presents pictures related to the selected word within the content of the topic. If a user selects the video icon, the window presents videos related to the selected word within the content of the topic. If a user selects the audio icon, the window plays audio containing vocal information related to the selected word within the content of the topic.

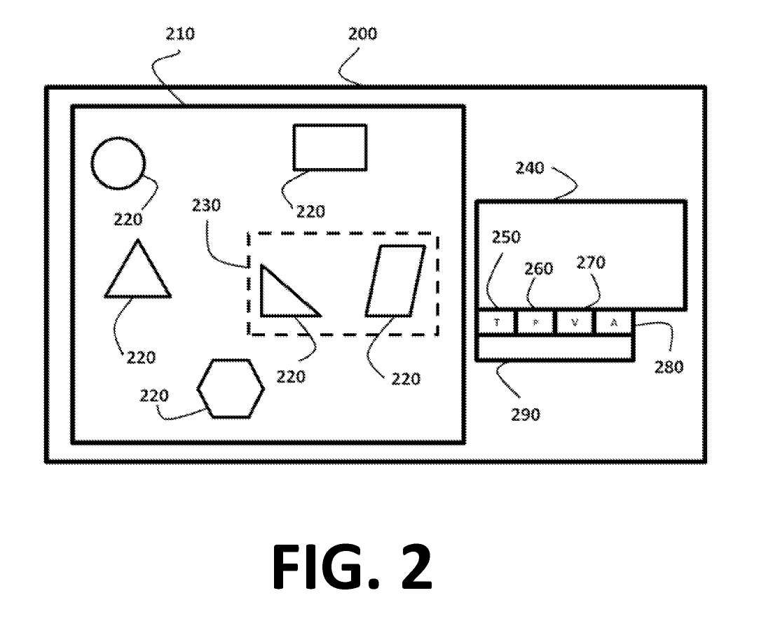

FIG. 2 illustrates a display 200 presenting a picture 210 containing a plurality of objects 220 where a user selected a part 230 of the picture by drawing a rectangle on the display to define the boundary area that contains the selected part of the picture. The window 240 is also drawn by the user on the display to indicate the position of presenting the second digital data. The text icon 250, the picture icon 260, the video icon 270, the audio icon 280, and the source box 290 enable the user to select the type and source of the second digital data as described previously. Using an object recognition technique to identify the objects in the picture and the objects of the selected part leads to defining the global keywords and the partial keywords. Combing the partial keywords with the global keywords generates a list of search keywords. Checking the availability of the related content in the source for each search keyword of the list eliminates the search keywords that do not have related content. Using the search keywords that have related content in the source enables extracting and presenting a second digital data related to the selected part of the picture within the content of the picture's objects.

For example, if a picture is presenting the Egyptian Pyramids and the Nile River, in addition to, some trees. In this case, the global keywords are “Egypt”, “Nile”, “River”, and “Trees”. If the part selected of the picture only includes some trees, in this case, the partial keyword will be “Trees”. Combining the partial keyword with the global keywords leads to a list of search keywords including four alternatives as follows; “Egypt Trees”, “Nile Trees”, “River Trees”, and “Trees Trees”. Checking the source may indicate available content for the first three search keywords “Egypt Trees”, “Nile Trees”, and “River Trees”. In this case, the second digital data will include text, pictures, videos, or audio related to these three search keywords. The user can select the type of the second digital data by selecting one of the four icons of the previous figure. In case of the search results of the second digital data have multiple results, the user can simultaneously view the multiple search results one time in the window, or successively view each one of the multiple search results in the window according to his/her needs or preference.

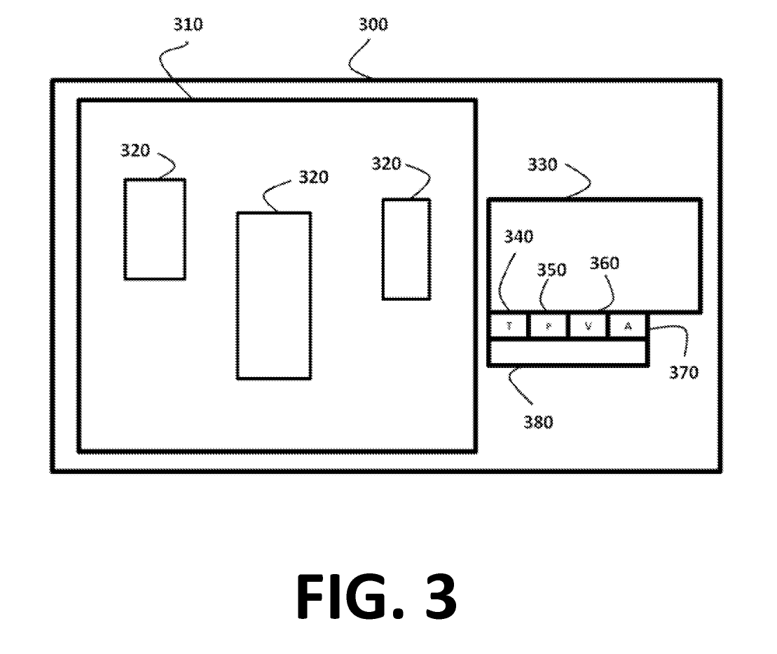

FIG. 3 illustrates a display 300 presenting a video 310 comprised of successive frames where each frame contains a plurality of objects 320. The window 330 is defined by the user's drawing on the display while the text icon 340, the picture icon 350, the video icon 360, the audio icon 370, and the source box 380 appear on the display when the window is drawn, as described previously. Once the user, at a certain moment, selects a frame of the video, the window presents a second digital data related to the content of the selected frame. In this case, the partial keywords represent the objects in the frame, while the global keywords represent the objects in the entire video. Recognizing the identity of the objects of the video and the frame is achieved by using an objects recognition technique. If the video frames contain subtitles or written information, then an optical recognition technique is utilized to extract these subtitles or written information and convert them into digital text.

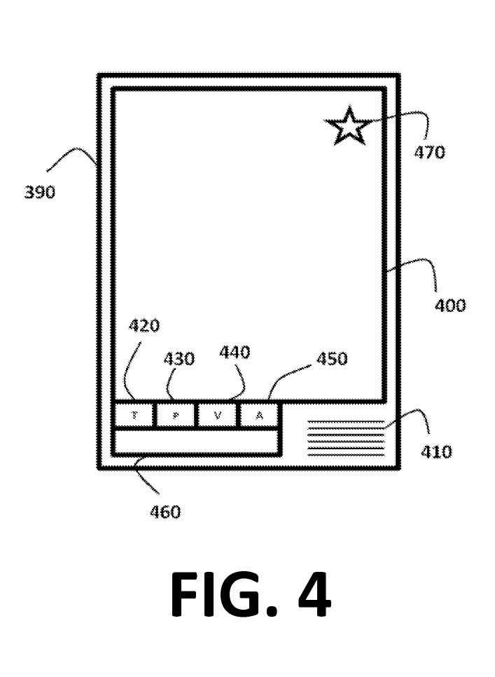

FIG. 4 illustrates a display 390 of a mobile phone where a window 400 on the display presenting text, pictures, videos, or audio related to the vocal information received and recorded by the sound recorder 410 of the mobile phone. The text icon 420, the picture icon 430, the video icon 440, and the audio icon 450 enable the user to select the type of the second digital data presented in the window. The source box 460 enables the user to select the source of the second digital data by typing the source name or selecting this name from a menu that includes names of different sources. The selection icon 470 enables the user to determine the start time and the end time of the selected part of the vocal information. This is achieved by pressing the selection icon for the first time to select the start time and pressing the selection icon for the second time to select the end time. The vocal information located between pressing the selection icon for the first time and the second time represents the selected part of the vocal information. The keywords of the selected part represent the partial keywords. The keywords of the entire vocal information represent the global keywords. It is important to note that the global keywords change during the continuation of the vocal information if new vocal information is recorded, which leads to new global keywords.

Generally, in all previous examples, each of the first digital data and the second digital data is presented on the same display, however, in another embodiment of the present invention, the second digital data is presented on another display than the display of the first digital data. For example, the first digital data can be displayed on a mobile phone display while the second digital data is displayed on a tablet display. Also, the first digital data can be displayed on a computer screen while the second digital data is displayed on a head mounted computer in the form of eyeglasses.

The first layer of the first digital data can be generated from data that is not digital. For example, the text of the first layer of the digital data can be captured from a printed newspaper or a printed book, where this text is converted into digital text using an optical recognition technique. Also, the picture can be a picture of a real time scene captured by a digital camera, and the video can be captured from a TV screen using a digital video camera. The same applies on the vocal information that can be recorded using a digital sound recorder where a voice recognition technique is utilized to convert the vocal information into text. This step of converting the data into a digital data is useful for augmented reality applications, especially when using the modern head mounted computers in the form of eyeglasses.

One of the main advantages of associating parts of a first layer of a first digital data with a second layer of a second digital data is classifying the second digital data in a detailed manner, especially when categorizing the first digital data with a plurality of identifiers. For example, when using the present invention with a book that can be classified with a plurality of identifiers such as the subject of the book, the educational level of the book, and the name of the book. For example, the subject of the book can be History, Geography, Mathematics, Physics, Chemistry, or Engineering. The educational level of the book can be Elementary School level, Middle School level, High School level, Undergraduate level, or Graduate Study level. The name of the book can be any given name. Assuming this book and other books were used to associate parts of their contents with second digital data such as text, pictures, videos, and audios. Each text, picture, video, or audio of the second digital data is associated with a search keyword, as described previously.

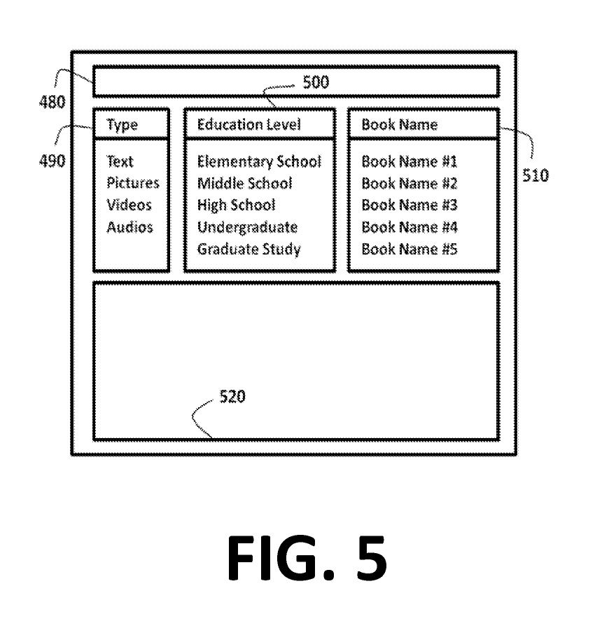

A database can be formed to associate each search keyword with a subject of a book, an educational level of the book, a name of a book, a type of a second digital data, and the source of the second digital data. This database is updated each time a user utilizes the present invention with a book. FIG. 5 illustrates an example of a graphical user interface for searching this database. As shown in the figure, a user can type a search keyword in the text box 480 where three menus appear to classify the search results in details. The first menu is the type menu 490 where a user can select the type of the search results such as text, pictures, videos, or audios. The second menu is the educational level menu 500 where a user can select from Elementary School, Middle School, High School, Undergraduate, or Graduate Study. The third menu is the book name menu 510 where a user can select a book with a certain name. The search result area 520 is the area on the display where the search results are presented. Such classification enables retrieving search results based on previous users' experience which is not available with other search engines in the market. However, the number of menus that classify the search results can be less or more than the three menus of the previous example. For example, a fourth menu can be added to include a selection between books, newspapers, magazines, or websites instead of only having one category of books.

According to the previous description, the present invention introduces a method for sorting layers of digital data. The method comprising of; classifying a first layer of a first digital data with a plurality of identifiers; associating a part of the first digital data with a second layer of a second digital data described with search keywords, type, and source; retrieving the second digital data from the source when the search keyword, the type, and the plurality of identifiers are provided; and presenting the second digital data in a predefined position. As described previously, the predefined position is a window defined with dimensions and location to present the second digital data on a device display.

In yet another embodiment of the present invention, a selected part of a first layer of a first digital data is associated with a second layer of annotation that typed manually to add notes or comments to the selected part. The selected part is analyzed to determine its partial keywords and the first digital data is analyzed to determine its global keywords. The partial keywords and the global keywords are combined together to generate the search keywords as described previously. The search keywords are associated with the annotation and stored in a database with identifiers classifying the first digital data. Once a user searches the database by providing one of the search keywords and the identifiers, then the annotation associated with the provided search keyword and the identifiers are retrieved and presented to the user.

The first digital data can be text, pictures, videos, or audio. The selected part of the first digital data can be one word or more of a text, an area of a picture, a frame of a video, or a time period of an audio. The partial keywords describe the one word or more selected of the text, the objects in the area selected of the picture, the content of the frame selected of the video, or the vocal information of the time period selected of the audio. The global keywords are the main keywords that describe the text, the objects of the picture, the content of the video, or the vocal information of the audio. The identifiers of the first digital data can be any classifications that categorize the first digital data. The annotations can be a digital text typed by a keyboard or can be a handwriting written by a pen, also the annotations can be vocal information recorded as an audio file.

Overall, the present invention discloses a first method for selecting a part of a first digital data to be augmented with a related content of a second digital data. Also, the present invention discloses a second method for sorting layers of digital data for searching purpose, in addition to, a third method for sorting and searching annotations. As described previously, presenting the second digital data of the first method, the search results of the second method, and the annotations of the third method are achieved through a predefined position of a window defined with certain parameters such as dimensions and location. However, such parameters can be associated with conditional rules provided by a user to fulfill his/her needs and preference. For example, the position of the window may depend on the blank area available on the device display in order to not hide any content the user is viewing. Also, the dimensions of the window may depend on the amount of the text, the size of the picture, or the resolution of video presented in the window. In case of having multiple windows simultaneously opened on the display, in this case, the dimensions and location of each window may depend on the total number of windows presented on the display.

1. A method for augmenting layers of digital data, the method comprising; presenting a first layer of a first digital data that can be described with global keywords; selecting a part of said first digital data that can be described with partial keywords whereas said part is to be augment with a second layer of a second digital data; providing a first input representing the type of said second digital data; providing a second input representing the source of said second digital data; providing a third input representing a predefined position for presenting said second digital data; analyzing said partial keywords relative to said global keywords to generate search keywords; extracting said second digital data from said source according to said search keywords and said type; and presenting said second digital data in said predefined position.

2. The method of claim 1 wherein said first digital data is a digital text presented on a display; said global keywords are the keywords that describe said digital text; said part is one word or more of said digital text; said partial keywords are the keywords that describe said one word or more; said type is text, pictures, videos, or audio; said source contains said second digital data; said predefined position is a window defined with dimensions and location relative to said part; and said analyzing means combining all possible alternatives of said partial keywords with said global keywords to create said search keywords.

3. The method of claim 1 wherein said first digital data is a picture presented on a display; said global keywords are the keywords that describe the objects of said picture; said part is an area of said picture containing one object or more; said partial keywords are the keywords that describe said one object or more; said type is text, pictures, videos, or audios; said source contains said second digital data; said predefined position is a window defined with dimensions and location relative to said part; and said analyzing means combining all possible alternatives of said partial keywords with said global keywords to create said search keywords.

4. The method of claim 1 wherein said first digital data is a video presented on a display; said global keywords are the keywords that describe the content of said video; said part is a frame of said video at a certain moment; said partial keywords are the keywords that describe the content of said frame; said type is text, pictures, videos, or audio; said source contains said second digital data; said predefined position is a window defined with dimensions and location relative to said video; and said analyzing means combining all possible alternatives of said partial keywords with said global keywords to create said search keywords.

5. The method of claim 1 wherein said first digital data is an audio containing vocal information played on a display; said global keywords are the keywords that describe the content of said audio; said part contains one word or more of said vocal information; said partial keywords are the keywords that describe said one word or more; said type is text, pictures, videos, or audio; said source contains said second digital data; said predefined position is a window defined with dimensions and location on said display; and said analyzing means combining all possible alternatives of said partial keywords with said global keywords to create said search keywords.

6. The method of claim 1 wherein said second digital data is presented on other display than said display of said first digital data.

7. The method of claim 1 wherein the dimensions and location of said predefined position change according to conditional rules.

8. The method of claim 2 wherein said digital data is generated from a picture of a text using an optical recognition technique.

9. The method of claim 3 wherein said objects are identified by analyzing information associated with said picture, or said objects are identified by using an objects recognition technique.

10. The method of claim 3 wherein said area completely covers said picture; said partial keywords describe said objects of said picture; and said search keywords are said global keywords.

11. The method of claim 3 wherein said picture is an image of a real time scene; and said global keywords change with the change of said real time scene.

12. The method of claim 4 wherein said content is identified by analyzing information associated with said video, or said content is identified by using an objects recognition technique.

13. The method of claim 5 wherein said vocal information is defined by analyzing information associated with said audio, or said vocal information is defined by using voice recognition technique.

14. The method of claim 5 wherein said audio is real time vocal information; and said global keywords change with the change of said real time vocal information.

15. A method for sorting layers of digital data; the method comprising; classifying a first layer of a first digital data with a plurality of identifiers; associating a part of said first digital data with a second layer of a second digital data described with search keywords, type, and source; retrieving said second digital data from said source when providing said search keyword, said type, and said plurality of identifiers; and presenting said second digital data in a predefined position.

16. The method of claim 15 wherein said first digital data is text, pictures, videos, or audios; said plurality of identifiers classifies said first digital data; said part is one word or more of said text, an area of said picture, a frame of said video, or a section of said audio; said second digital data is text, pictures, videos, or audios; said search keywords are the result of combining the keywords that describe said first digital data with the keywords that describe said part; said type is text, pictures, videos, or audios; said source contains said second digital data; and said predefined position is a window defined with dimensions and location.

17. A method for sorting and searching annotations, the method comprising; classifying a first layer of a first digital data with a plurality of identifiers; associating a selected part of said first digital data with a second layer of annotations; assigning said selected part with search keywords; storing said annotations associated with said search keywords and said plurality of identifiers; retrieving said annotations when providing said search keywords and said plurality of identifiers; and presenting said annotations in a predefined position.

18. The method of claim 17 wherein said first digital data is text, pictures, videos, or audios; said annotations is text; said search keywords are the result of combining the keywords that describe said first digital data with the keywords that describe said selected part; and said predefined position is a window defined with dimensions and location.

19. The method of claim 17 wherein said annotations are vocal information that can be recorded and saved as an audio file.

20. The method of claim 17 wherein said annotations are a handwriting that can be captured and saved as an image.
